(19) United States
(12) Patent Application Publication
(10) Pub. No.: US 2007/0069693 A1
(43) Pub. Date: Mar. 29, 2007

(54) Method and apparatus for improving cycle-life and capacity of a battery pack

(76) Inventors: Joseph Patino, Pembroke Pines, FL (US); Russell L. Simpson, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/223,003

(22) Filed: Sep. 9, 2005

(51) Int. Cl. H02J 7/00

(52) U.S. Cl. 320/132

(57) ABSTRACT

A charging system (108) supplies a source voltage (Vco, FIG. 5) and a source current (Ico, FIG. 5) to a plurality of battery cells (110). The charging system operates according to a method (200) including the steps of determining (202) a capacity for each of the plurality of battery cells (120 and 130), determining (204) a desired cutoff current (Ico1, FIG. 5) for a select one of the plurality of battery cells (120) having the smallest capacity, determining (206) an optimal source cutoff current according to the capacity of the select one of the plurality of battery cells, adjusting (208) the source current according to the optimal source cutoff current, and periodically applying (209) the source current after reaching the optimal source cutoff current.

### FIELD OF THE INVENTION

This invention relates generally to battery charging systems, and more particularly to a method and apparatus for improving cycle-life and capacity of a battery pack.

### BACKGROUND OF THE INVENTION

FIG. 1 is an illustration of a prior art system for charging conventional battery cells (depicted as CELL 1 and CELL 2). In this prior art system, two cells (CELL 1 and CELL 2) are charged by way of a source current (Ico) supplied by a conventional charging system (not shown). Prior art systems generally select the source current Ico according to the cutoff current of one of the cells. The reader's attention is directed to FIG. 2, which provides a diagram depicting the relationship of cycle-life (i.e., the number of functional charge and discharge cycles of a conventional battery cell) and the charging capacity of said cell as a function of source voltage and cutoff current. From this illustration, the cutoff current of a cell is preferably 40 mA and 4.2 volts.

Prior art systems such as shown in FIG. 1 set the source current Ico to cutoff current shown in FIG. 2. From the illustration of FIG. 1, CELL 1 and CELL2 have asymmetric capacities of 500 mAh (milli-Ampere hours) and 1000 mAH, respectively. The cutoff current at each cell can be determined from a product of the source current Ico and the ratio of the capacity of the cell in question to the total capacity of the cells. Accordingly, the cutoff current of CELL 1 (Ic1) is 13.3 mA, while the cutoff current of CELL 2 (Ic2) is 26.7 mA.

Referring back to FIG. 2, four curves are shown (10, 12A-B, and 14) at a variety of source voltages and cutoff currents. Starting with curve 10, a source voltage of 4.3V at a cutoff current of 40 mA provides a higher capacity charge (950 mAh), but a shorter cycle-life (500 cycles) than curves 12 and 14. Curve 12A provides a charge capacity of 875 mAh and a cycle-life of 750 cycles at a lower source voltage (4.2V), but the same cutoff current (40 mA). Thus, the lower source voltage (4.2V) provides a longer cycle-life, but a lower charge capacity. Curve 14 provides a charge capacity of 790 mAh and a cycle-life of greater than 1000 cycles at a source voltage of 4.1V and cutoff current of 40 mA.

From these curves 10-14 it should be apparent that varying the source voltage results in an inverse relationship between charge capacity and cycle-life. It is also important to note that when the cutoff current is significantly reduced, the cycle-life of the battery cell is significantly impacted. Curve 12B shows that when the cutoff current is reduced by half (20 mA) the cell's cycle-life is impacted by 20% (i.e., a cycle-life of 600 cycles-a reduction of 150 cycles from curve 12A). This latter effect has an undesirable impact on the cycle-life of parallel cells of the prior art system of FIG. 1.

### SUMMARY OF THE INVENTION

Embodiments in accordance with the invention provide a method and apparatus for improving cycle-life and capacity of a battery pack having at least a smaller capacity cell and a larger capacity cell. Although further adjusting the cutoff current of the smaller or smallest cell in the battery pack can improve the cycle life and capacity of the smaller cell and even the cycle life of the larger cell, such techniques alone will not improve the capacity of the larger cell (and of the battery pack overall). Embodiments herein enable both cells to be fully charged while maintaining each cells' optimum current cutoff point, thereby preserving cycle life performance.

In a first embodiment of the present invention, a charging system supplies a source voltage and a source current to a plurality of battery cells. The charging system can operate according to a method including the steps of determining a capacity for each of the plurality of battery cells, determining a desired cutoff current for a select one of the plurality of battery cells having the smallest capacity, determining an optimal source cutoff current according to the capacity of the select one of the plurality of battery cells, adjusting the source current according to the optimal source cutoff current, and upon the source current reaching the optimal source cutoff current, periodically applying the source current to the plurality of cells. This periodic application of the source current can be done until the plurality of cells reach an optimal capacity and cycle life. Note, the plurality of battery cells can correspond to a plurality of parallel battery cells.

In a second embodiment of the present invention, a device can include a plurality of battery cells, and a charging system for supplying a voltage and a source current to the plurality of battery cells. The charging system can be programmed to determine a capacity for each of the plurality of battery cells, determine a desired cutoff current for a select one of the plurality of battery cells having the smallest capacity, determine an optimal source cutoff current according to the capacity of the select one of the plurality of battery cells, adjust the source current according to the optimal source cutoff current, and upon the source current reaching the optimal source cutoff current, periodically applying the source current to the plurality of cells.

In a third embodiment of the present invention, a SCR (Selective Call Radio) can include a battery pack having a plurality of battery cells for supplying power to the SCR, a charging system for supplying a source voltage and a source current to the plurality of battery cells, a wireless transceiver for exchanging messages with a radio communication system, a memory for storing and processing data, and a processor for controlling the components of the SCR. The SCR can optionally include a display for conveying images to a user of the SCR and an audio system for conveying and receiving audible signals from the user of the SCR. The charging system under control of the processor can be programmed to determine a capacity for each of the plurality of battery cells, determine a desired cutoff current for a select one of the plurality of battery cells having the smallest capacity, determine an optimal source cutoff current according to the capacity of the select one of the plurality of battery cells, adjust the source current according to the optimal source cutoff current, and upon the source current reaching the optimal source cutoff current, periodically applying the source current to the plurality of cells.

### BRIEF DESCRIPTION OF THE DRAWINGS

FIG. 1 is an illustration of a prior art system for charging battery cells;

FIG. 2 is a diagram depicting the relationship of cycle-life and charging state of battery cells according to source voltage and cutoff current;

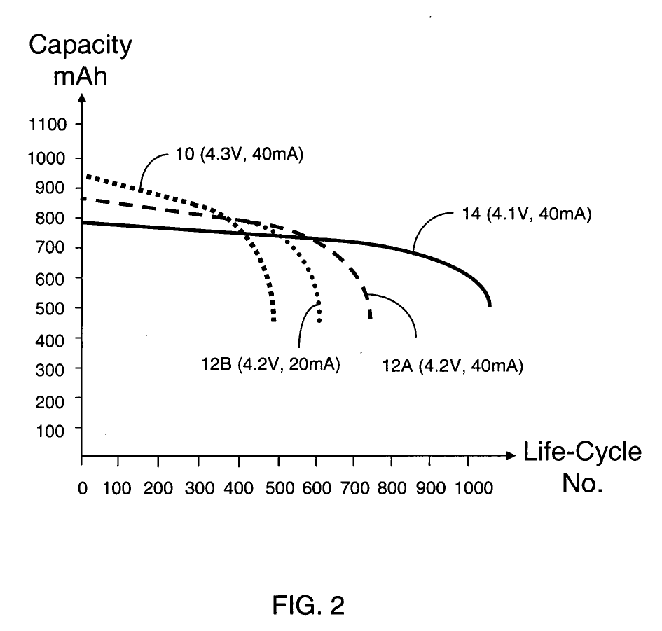

FIG. 3 is a block diagram of a device in accordance with an embodiment of the present invention;

FIG. 4 is a flow chart depicting a method operating in the device in accordance with an embodiment of the present invention; and

FIG. 5 is circuit diagram of a battery pack in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

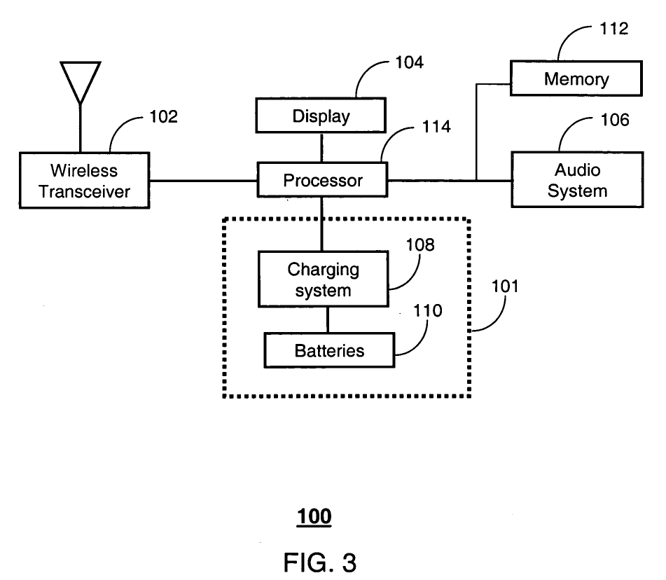

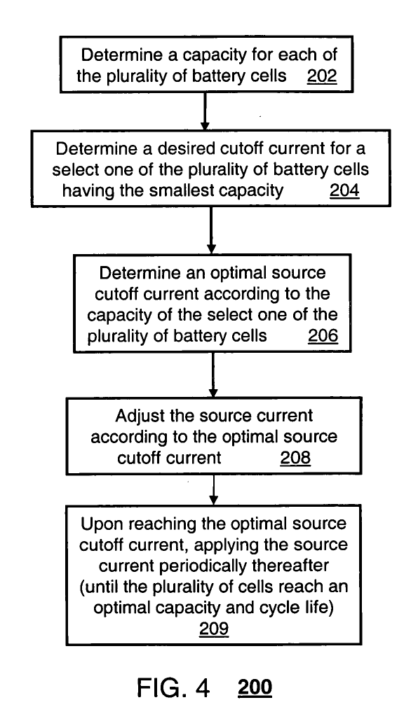

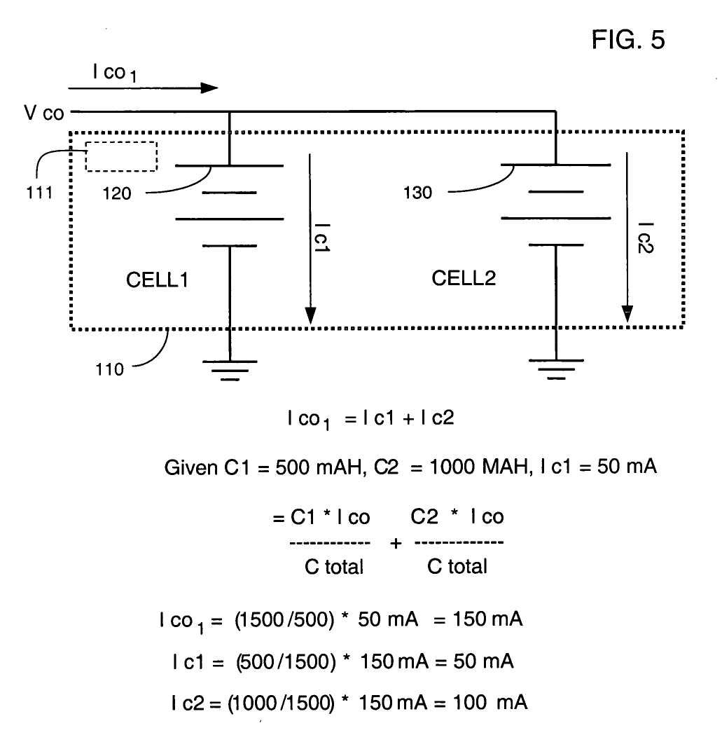

FIG. 3 is a block diagram of a device 101 in accordance with an embodiment of the present invention which can reside within a selective call receiver (SCR) 100 as will be further detailed below. The device 101 comprises a plurality of conventional battery cells 110 and a charging system 108. The charging system 108 includes, for example, a conventional regulation circuit (not shown) with conventional charge pumps if needed. The charging system 108 is coupled to the cells 110 for supplying an adjustable source voltage and source current for charging said cells 110. The battery cells 110 can be interconnected as shown in FIG. 5 and can be carried in a conventional battery pack. The battery cells 110 can be coupled in parallel to form the battery pack and each of the cells in the battery pack can have different capacities and be charged in accordance with a method 200 as shown in FIG. 4.

FIG. 4 is a flow chart depicting the method 200 operating, for example, in the device 101 in accordance with an embodiment of the present invention. The method 200 begins with step 202 where the charging system 108 is programmed to determine a capacity for each of the cells 120 and 130 among the plurality of cells 110 (See FIG. 5). In step 204, a desired cutoff current is determined for a select one of the battery cells 120 having the smallest capacity. In step 206, an optimal source cutoff current is determined according to the capacity of the select one of the cells 120 (among the plurality of cells 110). In step 208, the source current is adjusted according to the optimal source cutoff current determined in step 206. Upon reaching the optimal source cutoff current, the method 200 can then apply the source current periodically thereafter at step 209. The source current can be applied periodically until the plurality of cells 120 and 130 reach an optimal capacity while preserving the optimal cycle life. Note, the periodically applied source current can be a pulsing current that can continue indefinitely or terminate in any number of ways as contemplated herein as long as the plurality of cells reach the optimal capacity while preserving the optimal cycle life. For example, the current pulsing can be terminated based on a fixed time duration or a fixed voltage differential or based on any number of other criteria.

In other words, when the optimal source cutoff current is reached, instead of terminating the charge, the algorithm can go into a series of short wait and recharge states. This allows the cells 120 and 130 which are at different potentials based on their different charge currents to equalize. When the pause occurs, the smaller cell charges the bigger cell to reach voltage equilibrium. So by pulsing the cell pack periodically, the larger cell (130) is allowed to be fully charged via the smaller cell (120). In this fashion, both cells (120 and 130) are fully charged without exceeding their respective current cutoff thresholds to assure optimal capacity and cycle life performance. Another way of viewing several of the embodiments herein is that the methods and systems disclosed assure optimal cycle life while enabling the “topping off” of cells at the end of their recharge cycles to provide optimum capacity for all cells in a plurality of parallel cells.

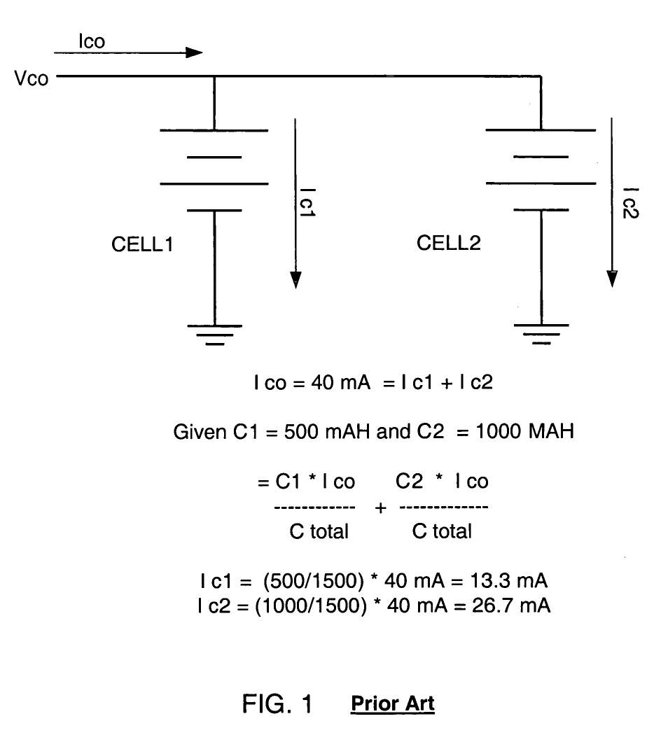

FIG. 5 is circuit diagram that illustrates the operation of the charging system 108 in accordance with method 200 of FIG. 4. The plurality of cells 110 are depicted as two parallel battery cells 120 and 130 (CELL 1 and CELL 2). Like the prior art system of FIG. 1, the capacity of these cells is 500 mAh and 1000 mAh, respectively, each having an ideal cutoff current in this example of 50 mA (or higher). In a supplemental embodiment of the invention, the capacity of each cell 120 and 130 and other relevant characteristics can be supplied to the charging system 108 by the cells 120 and/or 130 in step 202. That is, one or both cells (120 and/or 130) can include intelligent circuitry 111 such as a small conventional memory that can be programmed to supply the characteristics of one or both cells (120 and/or 130). Such characteristics can include one or more cutoff currents with its corresponding expected cycle-life performance for each current, and one or more source voltages and corresponding charge capacity for each voltage. This in turn provides flexibility to select a source voltage (Vco) and a source current (Ico) that optimizes cycle-life and charge capacity for the cells 110.

From this step, a designer of the charging system 108 can choose to balance the need for charge capacity and cycle-life of battery cells 110 or possibly implement an algorithm that can provide optimum charge capacity and cycle-life characteristics for all the battery cells 120 and 130 under certain circumstances. In determining this balancing effect, the designer considers the expected use behavior of the device 101, and determines therefrom a source voltage (Vco) and a cutoff current (Ic1) of the smallest capacity cell 120 (CELL 1). In the present example, the designer is assumed to choose the source voltage (Vco) at 4.2V in order to achieve a first predetermined charge capacity. Similarly, the designer is assumed to choose a cutoff current (Ico1) of the smallest cell 120 at 50 mA to achieve a predetermined cycle-life. It will be appreciated by an artisan with skill in the art that the source voltage (Vco) and cutoff current for the smallest cell (Ico1) (or cell having the smallest capacity) can be chosen differently as may be dictated by the use behavior of the device 101 and a desired outcome sought by the designer.

In step 206, an optimal source current (Ico) can be determined from the product of the desired cutoff current (Ic1=50 mA) and a ratio of a total capacity of the cells 120 and 130 (1500 mAh) and a capacity of the smallest cell 120 (500 mAh). This calculation provides a source current (Ico) of 150 mA. For a simple parallel cell configuration as shown in FIG. 5, the cutoff current of the second cell 130 (Ic2) can be determined from the difference of the source current (Ico) and the cutoff current of the smallest cell 120 (Ic1). Thus, providing a cutoff current for the second cell 130 (Ic2) of 100 mA. For a structure having more than two parallel cells, the cutoff current of the second cell 130 (Ic2) can be determined from the product of the source current (Ico) and the ratio of the capacity of said cell 130 (1000 mAh) and the total capacity of the cells 120 and 130 (1500 mAh). A similar calculation can be applied to determine the cutoff currents for third, fourth, and up to n^{th} parallel cells. Although 100 mA may be twice a desired cutoff current of the second cell 130, note that the second cell 130 is not fully charged yet. This is why the current pulsing is used to allow the first cell 120 (which is at a higher (unloaded) voltage based on its lower cutoff current) to charge the second cell 130 during the wait periods to reach voltage equilibrium. It should also be noted that where parallel cells do not have asymmetric charge capacities such as shown in FIG. 5 (i.e., each cell has the same charge capacity), any cell could be selected in step 204 as the smallest cell of method 200. In other words, symmetric charge capacities among cells enable the selection of any of the cell in a battery as the smallest cell (the cell having the smallest capacity) for the purposes herein.

In a supplemental embodiment of the present invention, the device 101 can be embodied in a selective call radio (SCR) 100 having conventional technology comprising the device 101, a wireless transceiver 102 for communicating with a conventional radio communication system, a display 104 for conveying images to a user of the SCR 100, an audio system 106 for receiving and conveying audible signals to and from the user of the SCR, a memory 112 for storing and processing data, and a processor 114 coupled to the foregoing components 102-112 for control thereof. The charging system 108 of the device 101 operates under the control of the processor 114 and is programmed according to the aforementioned method 200 of FIG. 4.

In light of the foregoing description, it should be recognized that embodiments could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents.

What is claimed is:

1. In a charging system supplying a source voltage and a source current to a plurality of battery cells, a method comprising the steps of:
determining a capacity for each of the plurality of battery cells;
determining a desired cutoff current for a select one of the plurality of battery cells having the smallest capacity;
determining an optimal source cutoff current according to the capacity of the select one of the plurality of battery cells;
adjusting the source current according to the optimal source cutoff current; and
upon the source current reaching the optimal source cutoff current,
periodically applying the source current to the plurality of cells.

2. The method of claim 1, wherein the plurality of battery cells correspond to a plurality of parallel battery cells.

3. The method of claim 2, wherein the optimal source cutoff current is the product of the desired cutoff current and a ratio of a total capacity of the plurality of parallel battery cells and a capacity of the select one of the plurality of parallel battery cells.

4. The method of claim 1, further comprising the step of maintaining a constant voltage across the terminals of the plurality of battery cells.

5. The method of claim 1, wherein the voltage applied to the plurality of battery cells is selected to optimize both a cycle-life and a charge capacity of each of the plurality of battery cells.

6. The method of claim 1, wherein the step of periodically applying the source current is done until the plurality of cells reach an optimal capacity while preserving an optimal cycle life.

7. The method of claim 1, wherein the determining the desired cutoff current further comprises the step of supplying from at least one of the plurality of battery cells one or more of a group of characteristics comprising one or more cutoff currents and corresponding expected cycle-life performance, and one or more source voltages and corresponding charge capacity.

8. The method of claim 1, further comprising the step of determining a desired voltage for supplying to the plurality of battery cells.

9. The method of claim 8, wherein the determining step further comprises the step of determining a desired voltage from each of the plurality of battery cells for optimizing the cycle-life of the corresponding battery cell.

10. The method of claim 8, wherein the determining step further comprises the step of determining a desired voltage from each of the plurality of battery cells for optimizing the charge capacity of the corresponding battery cell.

11. A device, comprising:
a plurality of battery cells; and
a charging system for supplying a source voltage and a source current to the plurality of battery cells, wherein the charging system is programmed to:
determine a capacity for each of the plurality of battery cells;
determine a desired cutoff current for a select one of the plurality of battery cells having the smallest capacity;
determine an optimal source cutoff current according to the capacity of the select one of the plurality of battery cells;
adjust the source current according to the optimal source cutoff current; and
upon the source current reaching the optimal source cutoff current,
periodically applying the source current to the plurality of cells.

12. The device of claim 11, wherein the optimal source current is the product of the desired cutoff current and a ratio of a total capacity of the plurality of parallel battery cells and a capacity of the select one of the plurality of parallel battery cells.

13. The device of claim 11, wherein the plurality of battery cells correspond to a plurality of parallel battery cells.

14. The device of claim 11, wherein the voltage applied to the plurality of battery cells is selected to optimize both a cycle-life and a charge capacity of each of the plurality of battery cells.

15. The device of claim 11, wherein the step of determining the capacity for each of the plurality of battery cells further comprises the step of supplying from each of the plurality of battery cells a corresponding capacity and a desired cutoff current for optimizing the cycle-life of the corresponding battery cell.

16. A SCR (Selective Call Radio), comprising:
a battery pack having plurality of battery cells for supplying power to the SCR;
a charging system for supplying a source voltage and a source current to the plurality of battery cells;
a wireless transceiver for exchanging messages with a radio communication system;
a memory for storing and processing data; and
a processor for controlling the components of the SCR, wherein charging system under control of the processor is programmed to:
determine a capacity for each of the plurality of battery cells;
determine a desired cutoff current for a select one of the plurality of battery cells having the smallest capacity;
determine an optimal source cutoff current according to the capacity of the select one of the plurality of battery cells;
adjust the source current according to the optimal source cutoff current; and
upon the source current reaching the optimal source cutoff current,
periodically applying the source current to the plurality of the cells.

17. The SCR of claim 16, wherein the optimal source current is the product of the desired cutoff current and a ratio of a total capacity of the plurality of parallel battery cells and a capacity of the select one of the plurality of parallel battery cells.

18. The SCR of claim 16, wherein the voltage applied to the plurality of battery cells is selected to optimize both a cycle-life and a charge capacity of each of the plurality of battery cells.

19. The SCR of claim 16, wherein the determining step (a) further comprises the step of supplying from each of the plurality of battery cells a corresponding capacity.

20. The SCR of claim 16, wherein the step of determining the desired cutoff current for the select one of the plurality of battery cells having the smallest capacity further comprises the step of supplying from each of the plurality of battery cells a desired cutoff current for optimizing the cycle-life of the corresponding battery cell.
